(19) United States
(12) Patent Application Publication
(10) Pub. No.: US 2024/0284967 A1
(43) Pub. Date: Aug. 29, 2024

(54) METHOD OF PREPARING FILTER FOR CIGARETTES

(71) Applicant: KT&G CORPORATION, Daejeon (KR)

(72) Inventors: Ki Jin AHN, Daejeon (KR); Hyeon Tae KIM, Daejeon (KR); Sun Hwan JUNG, Daejeon (KR); Min Hee HWANG, Daejeon (KR)

(73) Assignee: KT&G CORPORATION, Daejeon (KR)

(21) Appl. No.: 18/566,179

(22) PCT Filed: Oct. 18, 2022
(86) PCT No.: PCT/KR2022/015805

§ 371 Date: Dec. 1, 2023

(30) Foreign Application Priority Data
Oct. 18, 2021 (KR) 10-2021-0138698

(51) Int. Cl. A24D 3/02; A24D 3/04; A24D 3/10; A24D 3/14; B31F 1/08

(52) U.S. Cl. CPC A24D 3/022; A24D 3/0225; A24D 3/048; A24D 3/10; A24D 3/14; B31F 1/08

(57) ABSTRACT

The present disclosure relates to a filter for cigarettes and a method of preparing the filter, and provides a paper filter for cigarettes using paper and a cigarette including the paper filter. The filter for cigarettes provides a high level of satisfaction in smoking through high granular seating stability and eliminates a burnt taste. Various embodiments described herein in relation to the filter for cigarettes and the method of preparing the filter may be applicable.

### TECHNICAL FIELD

The disclosure relates to a method of preparing a filter for cigarettes using paper.

### BACKGROUND ART

In general, to produce cigarettes, various types of leaf tobacco may be mixed and processed to provide a desired scent and taste. The processed leaf tobacco may then be cut to produce cut tobacco leaf, and the cut tobacco leaf may be wrapped with cigarette paper to produce a cigarette. A filter may be attached to the cigarette as needed.

The filter used for a cigarette may be largely classified into an acetate filter, a paper filter, and a charcoal filter. The acetate filter that is generally used may contain cellulose acetate tow, and activated carbon and a plasticizer may be added to the cigarette filter.

The above description is information the inventor(s) acquired during the course of conceiving the present disclosure, or already possessed at the time, and is not necessarily art publicly known before the present application was filed.

### DISCLOSURE OF INVENTION

### Technical Goals

To solve the above-described issues, the present disclosure provides a cigarette filter including paper.

One aspect of the disclosure may provide a cigarette filter including granules that contains a great number of granules and a wetting agent.

Another aspect of the disclosure may provide a method of preparing a cigarette filter including granules.

Additional aspects of example embodiments will be set forth in part in the description which follows and, in part, will be apparent from the description, or may be learned by practice of the disclosure.

### Technical Solutions

According to an aspect, there is provided a cigarette filter including a paper filter formed by rolling base paper, a wetting agent applied to at least a portion of a surface of the paper filter, granules bound to the wetting agent, and a filter wrapper enveloping the paper filter.

According to another aspect, there is provided a cigarette including a cigarette column portion, a cigarette filter portion disposed on one side of the cigarette column portion and including at least one cigarette filter, and a tip paper enveloping a portion of the cigarette column portion and the cigarette filter portion.

According to still another aspect, there is provided a method of preparing a cigarette filter including: preparing crimped paper by crimping base paper; applying a wetting agent to the crimped paper through a plurality of nozzles; injecting granules onto paper containing the wetting agent; and wrapping paper on which the granules are seated with a filter wrapper.

### Advantageous Effects

The present disclosure provides a cigarette filter including paper.

According to an example embodiment of the disclosure, there is a provided a cigarette filter including granules, more particularly, a cigarette filter containing a large number of granules and a wetting agent.

According to another example embodiment of the disclosure, there is a provided a method of preparing a cigarette filter including granules.

### BRIEF DESCRIPTION OF DRAWINGS

FIG. 1 is a perspective view of a cigarette according to an example embodiment.

FIG. 2 is a cross-sectional view of a cigarette column portion according to an example embodiment.

FIG. 3 is a flowchart of a method of preparing a cigarette filter according to an example embodiment.

FIG. 4 is a schematic diagram of a device for preparing a cigarette filter according to an example embodiment.

FIGS. 5a, 5b, and 5c are diagrams illustrating a method of applying a wetting agent by a wetting agent applying device according to an example embodiment.

### BEST MODE FOR CARRYING OUT INVENTION

Hereinafter, example embodiments of the disclosure will be described with reference to the accompanying drawings. However, various alterations and modifications may be made to the example embodiments. The example embodiments are not construed as limited to the examples described in the disclosure and should be understood to include all changes, equivalents, and replacements within the idea and the technical scope of the disclosure.

The terminology used herein is for the purpose of describing some example embodiments only and is not to limit the example embodiments of the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

Unless otherwise defined, all terms used herein including technical or scientific terms have the same meanings as those generally understood by those having ordinary skill in the art to which the disclosure pertains. Terms, such as those defined in commonly used dictionaries, should be construed to have meanings matching the contextual meanings in the relevant art and the present disclosure, and are not to be construed as an ideal or excessively formal meaning unless otherwise defined herein.

In addition, when describing the example embodiments with reference to the accompanying drawings, like reference numerals refer to like constituent elements and a repeated description related thereto will be omitted. In the description of the example embodiments, a detailed description of well-known related structures or functions will be omitted when it is deemed that such a description will cause an ambiguous interpretation of the disclosure.

In addition, terms such as “first,” “second,” and the like may be used herein to describe various components, but the components are not limited to the terms. These terms should be used only to distinguish one component from another component. Also, it is to be understood that when a component is referred to as being “connected to” or “coupled to” another component, the component may be directly connected or coupled to the other component or intervening components may be present therebetween.

The same name may be used to describe an element having a common function as an element included in an example embodiment. Unless otherwise defined, the description of the element in the example embodiment may be applicable to the same element in other example embodiments, and thus duplicated descriptions thereof will be omitted for conciseness.

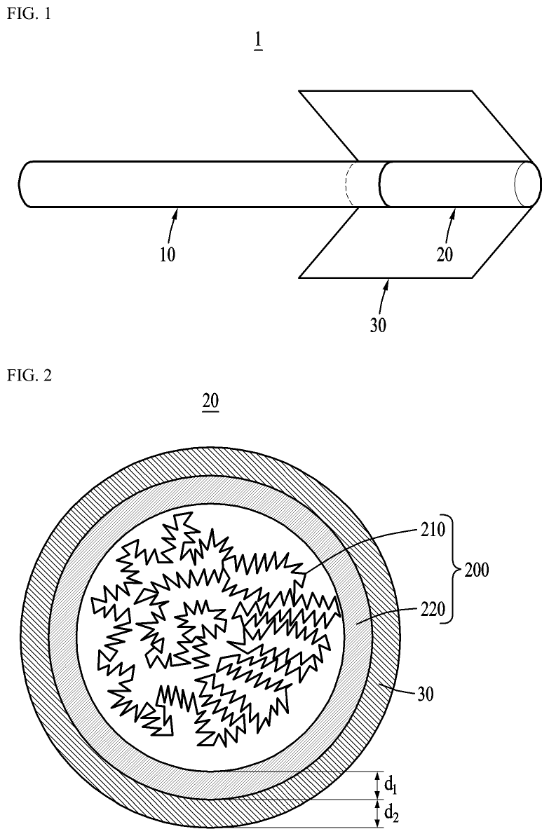

FIG. 1 is a perspective view of a cigarette according to an example embodiment.

According to an example embodiment, a cigarette 1 may include a cigarette column portion 10, a cigarette filter portion 20 disposed on one side of the cigarette column portion 10, and a tip paper 30 enveloping a portion of the cigarette column portion 10 and the cigarette filter portion 20.

According to an example embodiment, the cigarette filter portion 20 may include one or more filters for cigarettes. A filter for cigarettes used herein will be simply referred to as a cigarette filter hereinafter. According to an example embodiment, the cigarette filter portion 20 may include a single cigarette filter or may include two or more cigarette filters disposed sequentially in a longitudinal direction of the cigarette 1.

According to an example embodiment, as the cigarette column portion 10 of the cigarette 1 is heated, mainstream smoke may be generated to pass in the longitudinal direction of the cigarette 1 from the cigarette column portion 10 through the cigarette filter portion 20 to a user, and may thereby be inhaled by the user.

According to an example embodiment, the “longitudinal direction” described herein may refer to a longitudinal direction of the cigarette 1, the cigarette column portion 10, and/or the cigarette filter portion 20, and more specifically, to a direction parallel to a height of the cigarette 1, the cigarette column portion 10, and/or the cigarette filter portion 20 of a cylindrical shape. The “longitudinal direction” may have such a definition throughout the disclosure.

FIG. 2 is a cross-sectional view of a cigarette column portion according to an example embodiment.

According to an example embodiment, the cigarette filter portion 20 may include a cigarette filter 200 and a tip paper 30 enveloping the cigarette filter 200. According to an example embodiment, the cigarette filter 200 may include a paper filter 210 and a filter wrapper 220 enveloping the paper filter 210. The paper filter 210 may be prepared by crimping base paper through a crimping process. The base paper may be crimped to produce crimped paper. In this case, the crimping process may be a process of compressing and crimping the base paper and processing the base paper while allowing the base paper to pass through between two or more rollers.

According to an example embodiment, the cigarette filter 200 may include a wetting agent applied onto at least a portion of a surface of the paper filter 210. The wetting agent may be applied by being sprayed onto the entire surface or at least a portion of the surface of the paper filter 210. With the inclusion of the paper filter 210 containing the wetting agent, the cigarette filter 200 may have a desired degree of pressure drop (PD). The pressure drop (PD) may refer to the resistance of air felt by a user when the user inhales the air with a cigarette in their mouth. A sense of satisfaction in smoking felt by the user may vary depending on the PD, and it may thus be necessary to implement a target degree of PD.

According to an example embodiment, the cigarette filter 200 may include granules that are to be bound to the wetting agent. The wetting agent and the granules may be combined by injecting the granules into the paper filter 210 that is impregnated with a spraying agent as the wetting agent is sprayed on the entire surface or at least a portion of the surface of the paper filter 210. The wetting agent may serve as a binder binding granules and paper and may prevent the granules from being detached from the paper filter 210. Granules injected into an area of the surface of the paper filter 210 to which the wetting agent is not applied may not be able to secure sufficient bonding strength with the paper filter 210 and may thus be detached.

According to an example embodiment, the granules may be a mass percentage of 0.3 (mass %) to 5 mass %, based on the entirety of the cigarette filter portion 20.

According to an example embodiment, the filter wrapper 220 may have a constant thickness of d₁, and the tip paper 30 enveloping the cigarette filter 200 may have a constant thickness of d₂.

According to an example embodiment, the filter wrapper 220 may have a cylindrical shape and envelop the paper filter 210. The thickness d₁ of the filter wrapper 220 may be approximately 5 micrometers (μm) to approximately 30 μm. According to an example embodiment, the filter wrapper 220 may have the thickness d₁ in the numerical range described above, and may thus allow the heat to be desirably transferred to the entire cigarette filter 200 and may also prevent or reduce the leakage of liquid substances (e.g., the wetting agent) included in the cigarette filter 200 from the inside to the outside. According to an example embodiment, the filter wrapper 220 may have the thickness d₁ in the numerical range described above, thereby allowing the tensile strength of the filter wrapper 220 to be improved.

According to an example embodiment, the filter wrapper 220 may include at least one of aluminum (Al), copper (Cu), zinc (Zn), gold (Au), or iron (Fe). For example, the filter wrapper 220 may have a cylindrical shape formed of a metallic thin film, for example, the cylindrical shape of such a material as an aluminum foil, a copper foil, or a silver foil. According to an example embodiment, the filter wrapper 220 may be provided in the cylindrical shape formed of the metallic thin film, and may thus allow the heat to be desirably transferred to the entire cigarette filter 200 and may also prevent or reduce the leakage of liquid substances (e.g., the wetting agent) included in the cigarette filter 200 from the inside to the outside.

According to an example embodiment, the thickness d₂ of the tip paper 30 may be approximately 5 μm to approximately 30 μm. According to an example embodiment, the tip paper 30 may envelop a portion of the cigarette column portion 10 and the cigarette filter portion 20, and the filter wrapper 220 of the cigarette filter 200 may be enveloped by the tip paper 30.

According to an example embodiment, the tip paper 30 may include cellulose or dextrin. For example, the tip paper 30 may include cellulose.

According to an example embodiment, a total sum (d₁+d₂) of the respective thicknesses of the filter wrapper 220 and the tip paper 30 may be approximately 30 μm to 100 μm. According to an example embodiment, the total thickness of the filter wrapper 220 and the tip paper 30 may be the thickness (d₁+d₂) in the numerical range described above, and it is thus possible to prevent or reduce the leakage of liquid substances (e.g., the wetting agent) in the cigarette filter 200 from the inside to the outside.

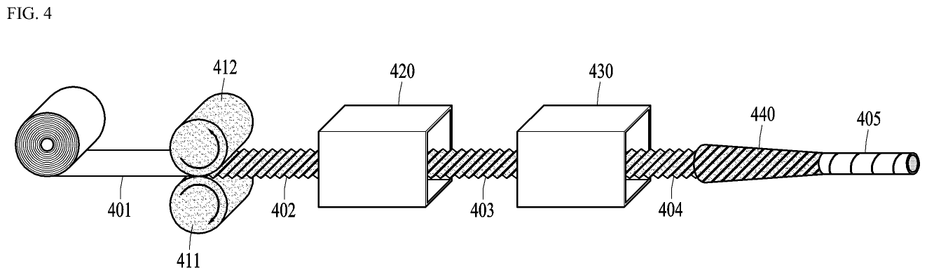

According to an example embodiment, the base paper may be used to prepare the paper filter 210 included in the cigarette filter 200. According to an example embodiment, the cigarette filter 200 may have performance (e.g., PD) that is determined by physical and chemical properties, such as, for example, a type and surface characteristics (e.g., porosity and water vapor permeability) of the base paper (e.g., base paper 401 of FIG. 4). According to an example embodiment, the properties of the wetting agent applied to the surface of the base paper and the adhesion of the wetting agent to the granules may be improved according to the type and the surface characteristics of the base paper.

According to an example embodiment, the base paper may have a low porosity.

For example, when the base paper has numerous pores, the wetting agent may be easily absorbed into the pores, and the wetting agent may not be desirably formed on the surface of the base paper. According to an example embodiment, the porosity of the base paper may be calculated by measuring Gurley porosity according to TAPPI T460, and the porosity of the base paper may be 10 s/100 cc³ or less. For example, the porosity of the base paper may be 9 s/100 cc³ or less, 8 s/100 cc³ or less, 7 s/100 cc³ or less, 6 s/100 cc³ or less, 5 s/100 cc³ or less, 4 s/100 cc³ or less, 3 s/100 cc³ or less, 2 s/100 cc³ or less, or 1 s/100 cc³ or less.

According to an example embodiment, when the porosity of the base paper is 10 s/100 cc³ or less, the wetting agent may be easily formed on the surface of the base paper, and the adhesion to injected granules may be improved. According to an example embodiment, when the porosity of the base paper is 10 s/100 cc³ or less, the seating stability and dispersibility of the granules may increase.

According to an example embodiment, as a basis weight and thickness of the base paper decrease, a width of the base paper of the paper filter 210 applied to the cigarette filter 200 may increase, and the adhesion to the injected granules and the seating stability of the granules may be improved. According to an example embodiment, the base paper may have the basis weight of 15 g/m² to 30 g/m². For example, the basis weight of the base paper may be 15 g/m² or more, 16 g/m² or more, 17 g/m² or more, 18 g/m² or more, 19 g/m² or more, 20 g/m² or more, 21 g/m² or more, 22 g/m² or more, 23 g/m² or more, 24 g/m² or more, 25 g/m² or more, 26 g/m² or more, 27 g/m² or more, 28 g/m² or more, or 29 g/m² or more, or 29 g/m² or less, 28 g/m² or less, 27 g/m² or less, 26 g/m² or less, 25 g/m² or less, 24 g/m² or less, 23 g/m² or less, 22 g/m² or less, 21 g/m² or less, 20 g/m² or less, 19 g/m² or less, 18 g/m² or less, 17 g/m² or less, or 16 g/m² or less, or alternatively one included in a range between two selected among the foregoing values. According to an example embodiment, the basis weight of the base paper may be desirably 16 g/m² to 26.5 g/m².

According to an example embodiment, the base paper may have a width of 200 millimeters (mm) to 300 mm. According to an example embodiment, the width of the base paper may be a factor determining a circumference of the paper filter 210 of the cigarette filter 200, and the paper filter 210 may be formed by crimping the base paper and be formed by rolling the base paper in a direction perpendicular to the longitudinal direction of the cigarette 1. According to an example embodiment, the width of the base paper may determine the circumference of the paper filter 210 of the cylindrical shape included in the cigarette filter 200. According to an example embodiment, the width of the base paper may be measured as a length in the direction perpendicular to the longitudinal direction of the cigarette 1 when the paper filter 210 being rolled is unrolled on a plane.

For example, the width of the base paper may be 200 mm or more, 210 mm or more, 220 mm or more, 230 mm or more, 240 mm or more, 250 mm or more, 260 mm or more, 270 mm or more, 280 mm or more, or 290 mm or more, or 290 mm or less, 280 mm or less, 270 mm or less, 260 mm or less, 250 mm or less, 240 mm or less, 230 mm or less, 220 mm or less, or 210 mm or less, or alternatively one included in a range between two selected from the foregoing values.

According to an example embodiment, when the width of the base paper is out of the foregoing numerical range, the circumference of the paper filter 210 of the cylindrical shape formed by rolling the base paper may be extremely small or large. In this case, when preparing the paper filter 210 of the cylindrical shape having the same circumference as the cigarette column portion 10, a space inside the cigarette filter 200 may be extremely large or narrow, and thus an ability to remove harmful substances of mainstream smoke and/or the passing performance of the mainstream smoke may be reduced.

According to an example embodiment, a product of the width and the basis weight of the base paper may be 5.2 g/m to 5.6 g/m. According to an example embodiment, when the product of the width and the basis weight of the base paper is included in the foregoing numerical range, it may be easy to prepare a filter and achieve PD (e.g., approximately 80 millimeters of water gauge (mmWG)). In addition, according to an example embodiment, when the product of the width and the basis weight of the base paper is included in the foregoing numerical range, the granules injected into the paper filter 210 may be easily seated without being detached, and the uniformity of smoking tastes felt by users using the cigarette 1 may be improved.

According to an example embodiment, the paper filter 210 may be of the cylindrical shape having a circumference of 20 mm to 25 mm. According to an example embodiment, the paper filter 210 may be formed by rolling the base paper to have a cylindrical shape. According to an example embodiment, the paper filter 210 may be of the cylindrical shape having the circumference of desirably 20 mm to 24 mm, and more desirably, 21 mm to 23 mm. According to an example embodiment, the paper filter 210 may be formed by rolling crimped paper prepared by crimping the base paper, and be prepared by rolling the base paper to have the cylindrical shape when being rolled. In this case, the circumference of the paper filter 210 may be measured from a circumference of the bottom thereof after being rolled to be the cylindrical shape. Alternatively, it may be replaced by a measured circumference of the cigarette filter 200 because the thickness of the filter wrapper 220 is thinner than the paper filter 210.

According to an example embodiment, the wetting agent may be applied onto at least a portion of the surface of the paper filter 210, and may be disposed to be formed on the surface of the paper filter 210. According to an example embodiment, the wetting agent may include at least one of glycerin, guar gum, starch, methyl cellulose, ethylene vinyl acetate (EVA), gum arabic, or propylene glycol.

According to an example embodiment, when an excessive amount of the wetting agent is applied onto the surface of the paper filter 210, the seating stability of the granules may be reduced. Conversely, when an extremely small amount of the wetting agent is applied onto the surface of the paper filter 210, the granules may be easily detached. According to an example embodiment, an amount of the wetting agent to be applied to the surface of the paper filter 210 based on the longitudinal direction of the cigarette 1 and/or the paper filter 210 may be 0.5 mg/mm to 5 mg/mm. For example, the amount of the wetting agent to be applied to the surface of the paper filter 210 may be 4 mg/mm or less, 3 mg/mm or less, 2 mg/mm or less, or 1 mg/mm or less, and desirably 0.5 mg/mm to 4 mg/mm, 0.5 mg/mm to 3 mg/mm, or 0.5 mg/mm to 2 mg/mm.

According to an example embodiment, the cigarette filter 200 may include granules. According to an example embodiment, the granules may be injected and then be seated on the paper filter 210, thereby improving the bonding strength of the wetting agent to the paper filter 210. According to an example embodiment, the granules may have a coating layer formed on a surface thereof. According to an example embodiment, the coating layer formed on the surface of the granules may prevent the granules from being broken or crumbled. The granules may be broken or crumbled by the wetting agent or by an external impact, or may be broken or crumbled naturally over time. According to an example embodiment, the coating layer formed on the surface of the granules may protect the granules from an external impact.

According to an example embodiment, the coating layer may include at least one of microcrystalline cellulose, anhydrous lactose, Cellactose 80 (co-processed 75% microcrystalline cellulose and 25% lactose), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethylcellulose calcium, sodium carboxymethylcellulose, cellulose, silicified microcrystalline cellulose, cellulose acetate, ceratonia, chitosan, copovidone, corn starch, pregelatinized starch, dextrate, dextrin, dextrose, erythritol, ethyl cellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxylglycerides, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, carnauba, caranway, sugarcane wax, myrtle wax, gum arabic, locust bean wax, guar gum, alginate, carrageenan, or pectin.

According to an example embodiment, as the coating layer may include at least one of microcrystalline cellulose, anhydrous lactose, Cellactose 80 (co-processed 75% microcrystalline cellulose and 25% lactose), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethylcellulose calcium, sodium carboxymethylcellulose, cellulose, silicified microcrystalline cellulose, cellulose acetate, ceratonia, chitosan, copovidone, corn starch, pregelatinized starch, dextrate, dextrin, dextrose, erythritol, ethyl cellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxylglycerides, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, carnauba, caranway, sugarcane wax, myrtle wax, gum arabic, locust bean wax, guar gum, alginate, carrageenan, or pectin, and may thereby prevent the granules from being broken by the wetting agent.

According to an example embodiment, the granules may have a filling density of 0.65 g/cc to 0.80 g/cc based on the entirety of the cigarette filter 200. According to an example embodiment, the filling density of the granules may be determined by an injected amount of the granules, and the granules may be injected such that the filling density is in the numerical range described above to prevent the granules from being broken.

For example, the filling density of the granules may be 0.65 g/cc or more, 0.70 g/cc or more, or 0.75 g/cc or more, or 0.80 g/cc or less, 0.75 g/cc or less, or 0.70 g/cc or less, or alternatively one included in a range between two selected from among the foregoing values.

According to an example embodiment, the granules may include at least one of activated carbon, cut tobacco leaf granules, or red ginseng residue granules. For example, the granules may be activated carbon.

According to an example embodiment, the granules may be injected into the paper filter 210 and seated on the surface thereof, and 3 mg/mm to 5 mg/mm of the granules may be injected based on the longitudinal direction of the paper filter 210. For example, the injected amount of the granules may be 3 mg/mm or more or 4 mg/mm or more, or 5 mg/mm or less or 4 mg/mm or less, or alternatively one included in a range between two selected from among the foregoing values.

According to an example embodiment, when the injected amount of the granules is 3 mg/mm to 5 mg/mm, it is possible to prepare a cigarette filter that has a desirable smoking taste and a desirable transfer amount of nicotine and moisture in mainstream smoke.

According to an example embodiment, an average diameter of the granules may be 0.45 mm to 0.60 mm. For example, the average diameter of the granules may be 0.45 mm or more, 0.50 mm or more, or 0.55 mm or more, or 0.60 mm or less, 0.55 mm or less, or 0.50 mm or less, or alternatively one included in a range between two selected from the foregoing values.

According to an example embodiment, a total equivalent of the granules may be 35% or more. According to an example embodiment, the higher an equivalent of the granules, the better a cigarette taste. For example, the total equivalent of the granules may be desirably 40% or more.

According to an example embodiment, the paper filter 210 may have a water resistance of 5% or more. According to an example embodiment, the paper filter 210 may have a high water resistance, and thus the wetting agent may be easily formed on the surface. For example, the water resistance of the paper filter 210 may be desirably 10% or more.

According to an example embodiment, the paper filter 210 may further include a flavoring agent. According to an example embodiment, the flavoring agent may include an herbal flavoring substance. According to an example embodiment, the flavoring agent may be dispersed on at least a portion of the surface of the paper filter 210.

According to an example embodiment, the filter wrapper 220 may include a material that may be heated by an induced magnetic field. According to an example embodiment, the filter wrapper 220 may include at least one of aluminum (Al), copper (Cu), zinc (Zn), gold (Au), or iron (Fe). According to an example embodiment, the filter wrapper 220 may have a cylindrical shape formed with such a material as an aluminum foil, a copper foil, or a silver foil. According to an example embodiment, the material that may be heated by the induced magnetic field may include at least one of an aluminum foil, a copper foil, or a silver foil.

According to an example embodiment of the present disclosure, a cigarette filter may include a paper filter formed by rolling base paper, a wetting agent applied to at least a portion of a surface of the paper filter, granules bound to the wetting agent, and a filter wrapper enveloping the paper filter.

According to an example embodiment, a width of the base paper may be 200 mm to 250 mm.

According to an example embodiment, the base paper may have a basis weight of 15 g/m² to 30 g/m².

According to an example embodiment, a product of the width and the basis weight of the base paper may be 5.2 g/m to 5.6 g/m.

According to an example embodiment, the paper filter may be of a cylindrical shape having a circumference of 20 mm to 25 mm.

According to an example embodiment, the wetting agent may include at least one of glycerin, guar gum, starch, methyl cellulose, ethylene vinyl acetate (EVA), gum arabic, or propylene glycol.

According to an example embodiment, an applied amount of the wetting agent may be 1 mg/mm to 5 mg/mm based on a longitudinal direction of the paper filter.

According to an example embodiment, the paper filter may have a water resistance of 5% or more.

According to an example embodiment, 3 mg/mm to 6 mg/mm of the granules may be included based on a length of the paper filter.

According to an example embodiment, the granules may have a coating layer formed on a surface thereof.

According to an example embodiment, the coating layer may include at least one of microcrystalline cellulose, anhydrous lactose, Cellactose 80 (co-processed 75% microcrystalline cellulose and 25% lactose), isomalt, dibasic dihydrate calcium phosphate, calcium carbonate, calcium lactate, dibasic anhydrous calcium phosphate, tribasic calcium phosphate, calcium silicate, calcium sulfate, carbomer, carboxymethylcellulose calcium, sodium carboxymethylcellulose, cellulose, silicified microcrystalline cellulose, cellulose acetate, ceratonia, chitosan, copovidone, corn starch, pregelatinized starch, dextrate, dextrin, dextrose, erythritol, ethyl cellulose, fructose, fumaric acid, glyceryl monooleate, glyceryl monostearate, glyceryl palmitostearate, hydroxyethyl cellulose, hydroxyethylmethyl cellulose, hydroxypropyl betadex, hydroxypropyl cellulose, hydroxypropyl starch, hypromellose, hypromellose acetate succinate, kaolin, lactitol, anhydrous lactose, lactose monohydrate, magnesium carbonate, magnesium oxide, maltitol, maltodextrin, maltose, mannitol, methylcellulose, pectin, polaxamer, polycarbophil, polydextrose, poly (DL-lactic acid), polyethylene glycol, polyethylene oxide, polymethacrylate, polyoxylglycerides, polyvinyl alcohol, povidone, shellac, simethicone, sodium alginate, sodium chloride, sorbitol, starch, pregelatinized starch, sucrose, sugar spheres, sulfobutyl ether B-cyclodextrin, titanium dioxide, trehalose, microcrystalline wax, white wax, yellow wax, xanthan gum, xylitol, beeswax, candelilla, carnauba, caranway, sugarcane wax, myrtle wax, gum arabic, locust bean wax, guar gum, alginate, carrageenan, or pectin.

According to an example embodiment, the granules may have a filling density of 0.65 g/cc to 0.80 g/cc based on the entirety of the cigarette filter.

According to an example embodiment, the granules may include at least one of activated carbon, cut tobacco leaf granules, or red ginseng residue granules.

According to an example embodiment, an injected amount of the granules may be 3 mg/mm to 5 mg/mm based on the longitudinal direction of the paper filter.

According to an example embodiment, an average diameter of the granules may be 0.45 mm to 0.60 mm.

According to an example embodiment, a total equivalent of the granules may be 35% or more.

According to an example embodiment, the paper filter may further include a flavoring agent.

According to an example embodiment of the present disclosure, a cigarette may include a cigarette column portion, a cigarette filter portion disposed on one side of the cigarette column portion and including at least one cigarette filter, and a tip paper enveloping a portion of the cigarette column portion and the cigarette filter portion.

According to an example embodiment, granules may account for 0.3 mass % to 5 mass %, based on the entirety of the cigarette filter portion.

According to an example embodiment, the tip paper may include at least one of aluminum (Al), copper (Cu), zinc (Zn), gold (Au), or iron (Fe).

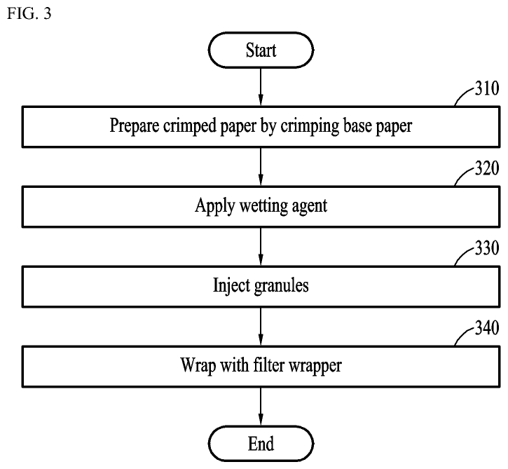

FIG. 3 is a flowchart of a method of preparing a cigarette filter according to an example embodiment.

A method of preparing a cigarette filter according to another example embodiment of the present disclosure may include step 310 of preparing crimped paper by crimping base paper, step 320 of applying a wetting agent onto the crimped paper through a plurality of nozzles, step 330 of injecting granules onto paper containing the wetting agent, and step 340 of wrapping paper on which the granules are seated with a filter wrapper.

FIG. 4 is a schematic diagram of a device for preparing a cigarette filter according to an example embodiment.

Referring to FIG. 4, illustrated is a device for preparing a cigarette filter (e.g., the cigarette filter 20 of FIG. 1).

According to an example embodiment, step 310 of preparing the crimped paper by crimping the base paper may be performed by a first roller 411 and a second roller 412, and base paper 401 may be crimped to produce the crimped paper. According to an example embodiment, the base paper 401 may be fed into a gap between the first roller 411 and the second roller 412, and in this case, the base paper 401 may be transferred by various transfer means. For example, the transfer means for the base paper 401 may include a roller, a conveyor belt, or both. A transfer path of the base paper 401 may be set in various ways according to the number of rollers and/or conveyor belts, and/or the arrangement thereof.

According to an example embodiment, the transfer path of the base paper 401 may be set in various ways. For example, the transfer path may be set as a straight path, a curved path, or a U-shaped path. However, the transfer path of the base paper 401 may be determined by various factors, such as, for example, an arrangement of a processing device, and is not limited to the example paths described above.

According to an example embodiment, the first roller 411 and the second roller 412 may perform a crimping process by compressing and crumpling the base paper 401. According to an example embodiment, the first roller 411 and the second roller 412 may rotate in opposite directions to transfer the base paper 401 on which the crimping process has been performed to a subsequent processing device. As the crimping process is performed, the base paper 401 may be produced to be crimped paper 402, and a sufficient tensile force may be assigned to the crimped paper 402. According to an example embodiment, the crimped paper 402 may pass through a wetting agent applying device 420 while floating in the air.

According to an example embodiment, to effectively compress and crumple the base paper 401, the first roller 411 and the second roller 412 may each include irregularities. According to an example embodiment, the crimping process may be smoothly performed by a rotational force of the first roller 411 and the second roller 412, and the base paper 401 may thus be compressed and wrinkled to be suitable for the application of the wetting agent and may thereby be produced to be the crimped paper 402.

According to an example embodiment, step 320 of applying the wetting agent may be performed to prepare wetting agent-containing paper 403 by applying a wetting agent to the crimped paper 402 through a plurality of nozzles. According to an example embodiment, step 320 of applying the wetting agent may be performed through the wetting agent applying device 420.

According to an example embodiment, step 320 of applying the wetting agent may be performed by spraying 0.5 mg/mm to 5 mg/mm of the wetting agent based on a longitudinal direction of the crimped paper 403. For example, an amount of the wetting agent to be applied may be 4 mg/mm or less, 3 mg/mm or less, 2 mg/mm or less, or 1 mg/mm or less, and desirably 0.5 mg/mm to 4 mg/mm, 0.5 mg/mm to 3 mg/mm, or 0.5 mg/mm to 2 mg/mm.

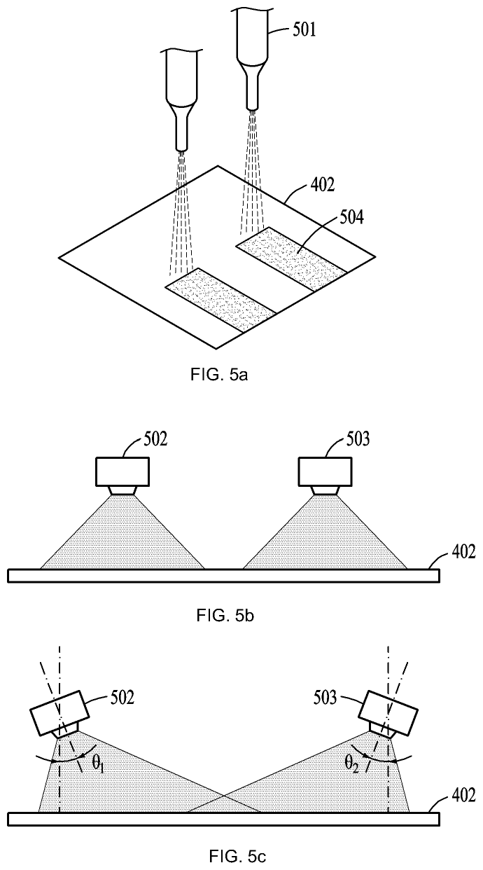

FIGS. 5a, 5b, and 5c are diagrams illustrating a method of applying a wetting agent by a wetting agent applying device according to an example embodiment.

Referring to FIG. 5a, the wetting agent applying device 420 may include a plurality of nozzles 501. According to an example embodiment, the crimped paper 402 may be transferred with a predetermined distance spaced apart from the nozzles 501. Onto the surface of the crimped paper 402, a wetting agent may be sprayed from the nozzles 501. According to an example embodiment, step 330 of preparing wetting agent-containing paper may include spraying the wetting agent from the nozzles 501 spaced apart from the crimped paper 402. According to an example embodiment, the nozzles 501 may be disposed by being spaced apart from the crimped paper 402.

According to an example embodiment, the nozzles 501 may be spaced apart upwardly from a transfer path of the crimped paper 402. When the nozzles 501 spray the wetting agent in a set direction, the wetting agent may be applied while the crimped paper 402 is moving along the transfer path. According to an example embodiment, when the transfer path of the crimped paper 402 is straight, a trace 504 of spraying the wetting agent onto the crimped paper 402 may be formed as a straight line.

According to an example embodiment, the plurality of nozzles 501 may be used to evenly apply the wetting agent onto the crimped paper 402. For example, two to ten nozzles 501 may be used, and the nozzles 501 may be aligned in a line in a vertical direction with respect to the transfer path of the crimped paper 402. According to an example embodiment, the nozzles 501 may be desirably two or three.

According to an example embodiment, as the nozzles 501 spray the wetting agent in a preset direction, the wetting agent may be sprayed on the crimped paper 402 to form a plurality of parallel traces 504. The wetting agent may be sprayed on as many as the number of the nozzles 501 simultaneously, and thus the content of the wetting agent in the crimped paper 402 may be improved. As the content of the wetting agent in the crimped paper 402 increases, a conditioning period may be shortened, and a desired PD may be more easily realized.

In this case, the conditioning period may refer to a period in which the wetting agent is absorbed into a paper filter of a cigarette filter and spread evenly. To shorten the conditioning period, it may be necessary to apply the wetting agent to the paper as evenly as possible in step 320 of applying the wetting agent such that the wetting agent is able to be spread fast throughout the paper.

FIGS. 5b and 5c are conceptual diagrams of the nozzles 501 viewed from the transfer path of the crimped paper 402. Referring to FIGS. 5b and 5c, the plurality of nozzles 501 may include a first nozzle 502 and a second nozzle 503, and an axis of each of the first nozzle 502 and the second nozzle 503 may form an angle with the vertical direction of the crimped paper 402. According to an example embodiment, the nozzles 501 may be arranged to be spaced apart from each other. For example, the axis of the first nozzle 502 may form a first angle θ₁ with the vertical direction of the crimped paper 402, and the axis of the second nozzle 503 may form a second angle θ₂ with the vertical direction of the crimped paper 402.

According to an example embodiment of FIG. 5b, the first angle θ₁ and the second angle θ₂ may each be 0°. According to an example embodiment of FIG. 5c, the first angle θ₁ and the second angle θ₂ may each be 15° to 45°.

According to an example embodiment, the nozzles 501 may include the first nozzle 502 and the second nozzle 503, and the first nozzle 502 and the second nozzle 503 may be twisted toward each other based on the vertical direction of the crimped paper 402. According to an example embodiment, the axes of the first nozzle 502 and the second nozzle 503 may form the first angle θ₁ and the second angle θ₂, respectively, with the vertical direction of the crimped paper 402. A vertical line of the crimped paper 402 and the axes of the first nozzle 502 and the second nozzle 503 may be positioned on one plane.

According to an example embodiment, the axis of the first nozzle 502 may have an angle of 15° to 45° toward the second nozzle 503 with respect to the vertical direction of the crimped paper 402, and the axis of the second nozzle 503 may have an angle of 15° to 45° toward the first nozzle 502 with respect to the vertical direction of the crimped paper 402. According to an example embodiment, the first angle θ₁ formed between the axis of the first nozzle 502 and the vertical direction of the crimped paper 402 may be formed toward the second nozzle 503 and may be 15° to 45°. In addition, the second angle θ₂ formed between the axis of the second nozzle 503 and the vertical direction of the crimped paper 402 may be formed toward the first nozzle 502 and may be 15° to 45°. According to an example embodiment, as the respective axes of the first nozzle 502 and the second nozzle 503 form predetermined angles with the vertical direction of the crimped paper 402, the wetting agent may be evenly sprayed on the crimped paper 402. In addition, the wetting agent may be evenly applied to the sides without being concentrated on the center of the crimped paper 402.

According to an example embodiment, the step 320 of applying the wetting agent may be performed by heating the wetting agent to 80° C. to 120° C. and applying the heated wetting agent. According to an example embodiment, in step 320 of applying the wetting agent, a viscosity of the wetting agent may be 0.008 Ns/m² to 0.08 Ns/m² and the wetting agent with the viscosity may be applied. For example, the viscosity of the wetting agent may be measured in a temperature range of 60° C. to 120° C. According to an example embodiment, the viscosity of the wetting agent may be desirably 0.014 Ns/m² to 0.03 Ns/m². According to an example embodiment, the viscosity of the wetting agent may decrease as the measured temperature increases, and the wetting agent may have a viscosity of 0.008 Ns/m² to 0.03 Ns/m² when measured at the temperature of 100° C.

According to an example embodiment, the wetting agent may include at least one of glycerin, guar gum, starch, methyl cellulose, ethylene vinyl acetate (EVA), gum arabic, or propylene glycol.

According to an example embodiment, the wetting agent may be obtained by adding a tobacco extract. According to an example embodiment, a cigarette filter (e.g., the cigarette filter 200 of FIG. 2) including the wetting agent to which the tobacco extract is added may produce an aerosol and nicotine simultaneously when being heated.

According to an example embodiment, the tobacco extract may include at least one of nicotine salt, nicotine, nicotine base, free nicotine, or nicotine derivatives. For example, the nicotine salt may be a substance naturally formed from leaf tobacco and may be produced through a reaction between nicotine and an acidic substance. It can be readily understood by those having ordinary skill in the art that the acidic substance may include lactic acid or pyruvic acid and may further include an organic acid capable of reacting with nicotine to form a nicotine salt.

According to an example embodiment, the wetting agent-containing paper 403 prepared through step 320 of applying the wetting agent may be produced to be granule-seated paper 404 through the step 330 of injecting the granules. According to an example embodiment, step 330 of injecting the granules may be performed by randomly injecting the granules onto the wetting agent-containing paper 403 by a granule injector 430, and more specifically, by allowing the granules to be seated on the wetting agent.

According to an example embodiment, step 340 of wrapping with a filter wrapper may be performed on the granule-seated paper 404 prepared through step 330 of injecting the granules. According to an example embodiment, the granule-seated paper 404 may be transferred through an outlet 440 to be collected at one position. According to an example embodiment, the outlet 440 may have a wide entrance and a narrow exit and may thus collect the granule-seated paper 404 into a narrow space in a cylindrical shape.

According to an example embodiment, the granule-seated paper 404 may be collected to be in a form suitable for being wrapped with the filter wrapper while passing through the outlet 440. According to an example embodiment, the outlet 440 may be of a shape having a wide entrance that is gradually narrowed to have a circular exit having a similar diameter to that of a cigarette (e.g., the cigarette 1 of FIG. 1). For example, the granule-seated paper 404 may be rolled to have the similar diameter to that of the cigarette as it passes through the outlet 440, and a paper filter (e.g., the paper filter 210 of FIG. 2) formed as described above may be discharged through the exit of the outlet 440.

According to an example embodiment, the granule-seated paper 404 discharged to the outlet 440 may be wrapped with the filter wrapper (e.g., the filter wrapper 220 of FIG. 2). According to an example embodiment, the granule-seated paper 404 may be wrapped with the filter wrapper to prepare a cigarette filter 405. According to an example embodiment, the granule-seated paper 404 discharged to the outlet 440 may be wrapped and fixed through the filter wrapper and may thereby be prevented from being unrolled by a restoring force.

According to an example embodiment, step 310 of preparing the crimped paper, step 320 of applying the wetting agent, step 330 of injecting the granules, and step 340 of wrapping with the filter wrapper may be performed during transfers along paths preset respectively.

According to an example embodiment of the present disclosure, a method of preparing a cigarette filter may include a step of preparing crimped paper by crimping base paper, a step of applying a wetting agent to the crimped paper through a plurality of nozzles, a step of injecting granules onto paper containing the wetting agent, and a step of wrapping paper on which the granules are seated with a filter wrapper.

According to an example embodiment, the step of applying the wetting agent may be performed by spraying 0.5 mg/mm to 5 mg/mm of the wetting agent based on a longitudinal direction of the crimped paper.

According to an example embodiment, the nozzles may be two or three.

According to an example embodiment, a step of preparing the paper containing the wetting agent may include spraying the wetting agent from the nozzles positioned by being spaced apart from the crimped paper.

According to an example embodiment, the nozzles may be disposed to be spaced apart from the crimped paper.

According to an example embodiment, the nozzles may be disposed to be spaced apart from each other, and an axis of the nozzles may have an angle of 15° to 45° with respect to a vertical direction of the crimped paper.

According to an example embodiment, the nozzles may include a first nozzle and a second nozzle, and an axis of the first nozzle may have an angle of 15° to 45° toward the second nozzle with respect to the vertical direction of the crimped paper. In addition, an axis of the second nozzle may have an angle of 15° to 45° toward the first nozzle with respect to the vertical direction of the crimped paper.

According to an example embodiment, the step of preparing the paper containing the wetting agent may include heating the wetting agent to 80° C. to 120° C. and applying this wetting agent.

According to an example embodiment, the wetting agent may have a viscosity of 0.008 Ns/m² to 0.08 Ns/m².

According to an example embodiment, the wetting agent may include at least one of glycerin, guar gum, starch, methyl cellulose, ethylene vinyl acetate (EVA), gum arabic, or propylene glycol.

According to an example embodiment, the wetting agent may be obtained by adding a tobacco extract.

According to an example embodiment, the tobacco extract may include at least one of nicotine salt, nicotine, nicotine base, free nicotine, or nicotine derivatives.

According to an example embodiment, the filter wrapper may include a material to be heated by an induced magnetic field.

According to an example embodiment, the material to be heated by the induced magnetic field may include at least one of an aluminum foil, a copper foil, or a silver foil.

According to an example embodiment, the step of preparing the crimped paper, the step of applying the wetting agent, the step of injecting the granules, and the step of wrapping with the filter wrapper may be performed during transfers along paths preset respectively.

Hereinafter, the present disclosure will be described in greater detail with reference to experimental examples and comparative examples.

However, the following examples are provided for illustrative purposes only and are not intended to limit the scope of the present disclosure.

### Experimental Example 1

To verify the seating stability of granules according to types and physical properties of base paper, cigarette filters were prepared using various types of base paper. In this case, a cigarette filter was prepared through a step of preparing crimped paper by crimping base paper, a step of applying a wetting agent to the crimped paper through a plurality of nozzles, a step of injecting granules onto paper containing the wetting agent, and a step of wrapping paper on which the granules are seated with a filter wrapper. As shown in Table 1 below, various types of base paper were used, 1 mg/mm of glycerin was applied as the wetting agent, and 5 mg/mm of shellac-coated activated carbon was injected as the granules. Table 1 below shows the granule seating stability of the cigarette filters using different types of base paper according to Experimental Example 1.

TABLE 1

| | | | | | Width × | |
|---|---|---|---|---|---|---|
| | Basis | | Reference | Paper | Basic | Granule |
| | weight | Paper | PD | width | weight | seating |
| Classif. | [g/m²] | classifi. | [mmWG] | [mm] | [g/m] | result |
| Example 1 | 35 | Crimped | 80 | 150 | 5.25 | Large |
| | | paper | | | | dropout |
| Example 2 | 60 | Crimped | 80 | 90 | 5.40 | Large |
| | | paper | | | | dropout |
| Example 3 | 16 | Non-porous | 80 | 340 | 5.44 | Large |
| | | paper | | | | dropout |
| Example 4 | 24 | Non-porous | 80 | 220 | 5.28 | Suitable |
| | | paper | | | | seating |
| Example 5 | 24 | Porous | 80 | 220 | 5.28 | Suitable |
| | | paper | | | | seating |
| Example 6 | 26.5 | Non-porous | 80 | 210 | 5.565 | Suitable |
| | | paper | | | | seating |

Referring to Table 1 above, the more non-porous the base paper, the better the seating stability of granules. In addition, it was verified that the seating stability of granules may be desirable when the basis weight is 15 g/m² to 30 g/m², and the seating stability of granules may be desirable when a product of the width and the basis weight of the base paper is 5.2 g/m to 5.6 g/m.

### Experimental Example 2

To verify the tobacco taste according to an injected amount of granules of a cigarette filter, cigarette filters were prepared by varying the injected amount of granules. In this case, a cigarette filter was prepared through a step of preparing crimped paper by crimping base paper, a step of applying a wetting agent to the crimped paper through a plurality of nozzles, a step of injecting granules onto paper containing the wetting agent, and a step of wrapping paper on which the granules are seated with a filter wrapper. As shown in Table 2 below, the taste evaluation was conducted on different injected amounts of granules, for which non-porous paper having a basis weight of 24 g/m² was used as base paper, 1 mg/mm of glycerin was applied as the wetting agent, and shellac-coated activated carbon was injected as the granules. In this case, the shellac-coated activated carbon had an average diameter of 0.45 mm to 0.60 mm, and a total equivalent thereof was 0.35%. Table 2 below shows cigarette filters and results of the cigarette taste evaluation according to different injected amounts of granules.

TABLE 2

| | Injected | | | |
|---|---|---|---|---|
| | amount | | | |
| | of granules | Taste | Smoke element | |
| Classifi. | [mg/mm] | evaluation | analysis result | Remarks |
| Example 7 | 1 | Weak taste | Insufficient nicotine | NA |
| | | | and water transfer | |
| Example 8 | 2 | Weak taste | Insufficient nicotine | NA |
| | | | and water transfer | |
| Example 9 | 3 | Weak taste | Insufficient nicotine | NA |
| | | | and water transfer | |
| Example 10 | 4 | Good taste | Good nicotine and | NA |
| | | | water transfer | |
| Example 11 | 5 | Good taste | Good nicotine and | NA |
| | | | water transfer | |
| Example 12 | 6 | Weak taste | Insufficient nicotine | NA |
| | | | and water transfer | |

Referring to Table 2 above, it was verified that a desirable nicotine and water transfer amount may be obtained when an injected amount of granules is 3 mg/mm to 5 mg/mm, and the smoking taste of a cigarette using such a cigarette filter with such an amount may be desirable.

### Experimental Example 3

To evaluate the seating stability of granules according to a type of a wetting agent of a cigarette filter, cigarette filters were prepared using various wetting agents. In this case, a cigarette filter was prepared through a step of preparing crimped paper by crimping base paper, a step of applying a wetting agent to the crimped paper through a plurality of nozzles, a step of injecting granules onto paper containing the wetting agent, and a step of wrapping paper on which the granules are seated with a filter wrapper. As shown in Table 3 below, the evaluation was conducted on different wetting agents, for which non-porous paper having a basis weight of 24 g/m² was used as base paper, 1 mg/mm of the wetting agent was applied, and shellac-coated activated carbon was used as the granules. Table 3 below shows the seating stability of granules according to different types of wetting agents according to Experimental Example 3.

TABLE 3

| | | Granule | |
|---|---|---|---|
| | Type of | seating | |
| Classifi. | wetting agent | stability | Remarks |
| Example 13 | EVA | Good | Odor in cigarette taste |
| Example 14 | Guar Gum | Good | Good long-term stability |
| Example 15 | Glycerin | Good | Poor long-term stability, |
| | | | but good taste |
| Example 16 | Methyl cellulose | Good | Odor in cigarette taste |

Referring to Table 3 above, it was verified that that EVA, guar gum, glycerin, and methyl cellulose may all be used as a wetting agent to improve the seating stability of granules, and it was verified that there is a slight difference only in the occurrence of odor or off-flavor.

While this disclosure includes specific example embodiments, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

### DESCRIPTION OF REFERENCE NUMERALS

1: Cigarette
10: Cigarette column portion
20: Cigarette filter portion
30: Tip paper
200: Cigarette filter
210: Paper filter
220: Filter wrapper
401: Base paper
402: Crimped paper
403: Wetting agent-containing paper
404: Granule-seated paper
405: Cigarette filter
411: First roller
412: Second roller
420: Wetting agent applying device
430: Granule injector
440: Outlet
501: Nozzle
502: First nozzle
503: Second nozzle
504: Trace

1. A method of preparing a cigarette filter, comprising:
preparing crimped paper by crimping base paper;
applying a wetting agent to the crimped paper through a plurality of nozzles;
injecting granules onto paper containing the wetting agent; and
wrapping paper on which the granules are seated with a filter wrapper,
wherein the applying of the wetting agent is performed by spraying 0.5 mg/mm to 5 mg/mm of the wetting agent based on a longitudinal direction of the crimped paper.

2. The method of claim 1, wherein the nozzles are two or three nozzles.

3. The method of claim 1, wherein the applying of the wetting agent to the crimped paper comprises:
spraying the wetting agent from the nozzles spaced apart from the crimped paper.

4. The method of claim 1, wherein the nozzles are disposed to be spaced apart from the crimped paper.

5. The method of claim 1, wherein the nozzles are arranged to be spaced apart from each other,
wherein an axis of the nozzles has an angle of 15 degrees (°) to 45° with respect to a vertical direction of the crimped paper.

6. The method of claim 1, wherein the nozzles comprise a first nozzle and a second nozzle,
wherein an axis of the first nozzle has an angle of 15° to 45° toward the second nozzle with respect to a vertical direction of the crimped paper, and
an axis of the second nozzle has an angle of 15° to 45° toward the first nozzle with respect to the vertical direction of the crimped paper.

7. The method of claim 1, wherein the applying of the wetting agent to the crimped paper comprises:
heating the wetting agent to 80° C. to 120° C.

8. The method of claim 1, wherein the wetting agent has viscosity of 0.008 Ns/m² to 0.08 Ns/m².

9. The method of claim 1, wherein the wetting agent comprises at least one of glycerin, guar gum, starch, methylcellulose, ethylene vinyl acetate (EVA), gum arabic, or propylene glycol.

10. The method of claim 9, wherein the wetting agent is obtained by adding a tobacco extract.

11. The method of claim 10, wherein the tobacco extract comprises at least one of nicotine salt, nicotine, nicotine base, free nicotine, or nicotine derivatives.

12. The method of claim 1, wherein the filter wrapper comprises a material to be heated by an induced magnetic field.

13. The method of claim 12, wherein the material to be heated by the induced magnetic field comprises at least one of an aluminum foil, a copper foil, or a silver foil.

14. The method of claim 1, wherein the preparing of the crimped paper, the applying of the wetting agent, the injecting of the granules, and the wrapping with the filter wrapper are performed through transfers along respective preset paths.
